(19) United States
(12) Patent Application Publication
(10) Pub. No.: US 2026/0228781 A1
(43) Pub. Date: Aug. 6, 2026

(54) INFORMATION PROCESSING DEVICE, INFORMATION PROCESSING METHOD, AND COMPUTER PROGRAM PRODUCT

(71) Applicants: KABUSHIKI KAISHA TOSHIBA, Kawasaki-shi (JP); TOSHIBA ENERGY SYSTEMS & SOLUTIONS CORPORATION, Kawasaki-shi (JP)

(72) Inventors: Ryoma FUKUHARA, Katsushika Tokyo (JP); Hiromasa SHIN, Yokohama Kanagawa (JP); Yoshiaki SHIGA, Kawasaki Kanagawa (JP); Yuki MIYACHI, Kawasaki Kanagawa (JP)

(73) Assignees: KABUSHIKI KAISHA TOSHIBA, Kawasaki-shi (JP); TOSHIBA ENERGY SYSTEMS & SOLUTIONS CORPORATION, Kawasaki-shi (JP)

(21) Appl. No.: 19/460,439

(22) Filed: Jan. 27, 2026

(30) Foreign Application Priority Data
Jan. 31, 2025 (JP) 2025-015286

(51) Int. Cl. G06Q 30/0273; G06Q 40/04; G06Q 50/06

(52) U.S. Cl. CPC G06Q 30/0275; G06Q 40/049; G06Q 50/06

(57) ABSTRACT

According to an embodiment, an information processing device comprising: one or more hardware processors configured to, using: a bid price for each of a plurality of traded objects with mutually different trading conditions and for each of a plurality of trading periods; and device information comprising a providable amount of the traded objects by a providing device configured to provide the traded objects, generate a bid plan so as to optimize an evaluation value of trading across the plurality of trading periods with a provision condition for the providing device to provide the traded object as a constraint, the bid plan comprising a pattern of the traded object to be traded among the plurality of traded objects, and a bid amount and a bid price of the traded object for each of the plurality of trading periods, the provision condition comprising a condition based on a providable amount.

### CROSS-REFERENCE TO RELATED APPLICATIONS

This application is based upon and claims the benefit of priority from Japanese Patent Application No. 2025-015286, filed on Jan. 31, 2025; the entire contents of which are incorporated herein by reference.

### FIELD

Embodiments described herein relate generally to an information processing device, an information processing method, and a computer program product.

### BACKGROUND

There is known an electric power trading market for trading electric power generated by power generation companies and the like. For example, in Japan, electric power is traded in a plurality of markets established by Japan Electric Power Exchange (JEPX). The markets include, for example, a spot market and a day-ahead market. In addition, adjusting power for electric power is traded, for example, through a supply-demand balancing market (Electric Power Reserve eXchange: EPRX).

To provide (offer) adjusting power to a market, energy storage devices such as storage batteries need to be charged in advance. During a charging time, an additional constraint arises to provide adjusting power to the market. In the supply-demand balancing market, a duration time after an activation command is different depending on five types of product categories (primary adjusting power, secondary adjusting power (1), secondary adjusting power (2), tertiary adjusting power (1), and tertiary adjusting power (2)). Due to this, an amount of charge to be secured in advance is different depending on a product category.

In the supply-demand balancing market, adjusting power for one day or for one week is simultaneously bid. Thus, maximizing a provision amount (a bid amount) of a certain block does not lead to maximizing revenue for one day or for one week in some cases.

### BRIEF DESCRIPTION OF THE DRAWINGS

FIG. 1 is a block diagram of an information processing device according to a first embodiment;

FIG. 2 is a flowchart of processing of generating a bid plan in the first embodiment;

FIG. 3 is a diagram for explaining an example of a method of adjusting a bid amount;

FIG. 4 is a block diagram of an information processing device according to a second embodiment;

FIG. 5 is a diagram illustrating an example of a bid-winning probability function;

FIG. 6 is a diagram illustrating an example of a bid-winning probability function;

FIG. 7 is a block diagram of an information processing device according to a third embodiment;

FIG. 8 is a diagram illustrating an example of a data structure of constraints;

FIG. 9 is a block diagram of an information processing device according to a fourth embodiment;

FIG. 10 is a diagram for explaining an example of charging;

FIG. 11 is a diagram for explaining an example of charging;

FIG. 12 is a flowchart of processing of generating a bid plan in the fourth embodiment; and

FIG. 13 is a hardware configuration diagram of the information processing device according to the first to the fourth embodiments.

### DETAILED DESCRIPTION

According to an embodiment, an information processing device comprising: one or more hardware processors configured to, using: a bid price for each of a plurality of traded objects with mutually different trading conditions in a market and for each of a plurality of trading periods that are units of bidding in the market; and device information comprising a providable amount of the traded objects by a providing device configured to provide the traded objects, generate a bid plan so as to optimize an evaluation value of trading across the plurality of trading periods with a provision condition for the providing device to provide the traded object as a constraint, the bid plan comprising a pattern of the traded object to be traded among the plurality of traded objects, and a bid amount and a bid price of the traded object for each of the plurality of trading periods, the provision condition comprising a condition based on a providable amount.

The following describes preferred embodiments of an information processing device according to the present invention in detail with reference to the attached drawings.

The following describes an example in which a market and a traded object in the market are a supply-demand balancing market and electric power (balancing capacity), but the market and the traded object are not limited thereto. Additionally, the following describes an example in which a providing device that provides electric power (a traded object) is an energy storage device, but the providing device is not limited thereto. An energy storage device is a device that can store energy (such as electric power) and provide the stored energy, for example, a storage battery and a pumped storage generator. In this example, a trading amount (a bid amount) representing an amount of a traded object (electric power) traded in a market corresponds to an amount of sold electric power or an amount of purchased electric power. In the supply-demand balancing market, balancing capacity as a traded object is traded in time units called blocks. The block corresponds to a trading period that is a unit of bidding in a market. A length of the block (block length) is, for example, 30 minutes. Balancing capacity as a traded object is called a product in some cases.

Herein, the following describes the supply-demand balancing market in Japan. The supply-demand balancing market is a mechanism in which a general power transmission and distribution company procures balancing capacity necessary for performing frequency control and adjusting supply and demand balance through market trading. The supply-demand balancing market is a market established in April 2021, and aims at stable supply of electric power, suppression of increases in electricity charges, and expansion of options and opportunities for consumers and companies. Along with the market opening for all products having started in April 2024, expansion of introduction of renewable energy, and termination of public offering of balancing capacity, expansion of trading is expected.

In the supply-demand balancing market, the following five types of products are traded in accordance with characteristics such as a response time and a duration time. In this manner, in the supply-demand balancing market, a plurality of products whose trading conditions are different from each other are traded objects. Each of the products is used when balancing capacity is required due to imbalance, a forecast error of renewable energy, intra-time fluctuation, and power source outage.
Tertiary balancing capacity (2): balancing capacity for responding to a forecast error of renewable energy using Feed-in Tariff (FIT) special scheme (1) and FIT special scheme (3). A response time is within 45 minutes, and a duration time is 3 hours.
Tertiary balancing capacity (1): balancing capacity for responding to a forecast error after gate close and power source outage. A response time is within 15 minutes, and a duration time is 3 hours.
Secondary balancing capacity (2): balancing capacity for responding to a forecast error (a long-period component) after gate close. A response time is within 5 minutes, and a duration time is 30 minutes or more.
   Secondary balancing capacity (1): balancing capacity for responding to intra-time fluctuation (a short-period component) and power source outage. A response time is within 5 minutes, and a duration time is 30 minutes or more.
   Primary balancing capacity: balancing capacity for responding to intra-time fluctuation (a very short-period component) and power source outage. A response time is within 10 seconds, and a duration time is 5 minutes or more.

The supply-demand balancing market is greatly different from a spot market in that bidding is performed by specifying a kW unit price and a kWh unit price, a payment unit price is determined in accordance with a bid unit price (a Pay as Bid method is adopted), presence/absence of a response is unknown at a time of contract, and only a kW unit price is disclosed as a trading record, and the like. These differences make selection of a bid unit price and a revenue outlook difficult, and are considered to constitute a barrier to entry to the supply-demand balancing market.

The supply-demand balancing market has constraints relating to prices. One of the constraints is an upper limit price explicitly set in the market. The upper limit price is set to avoid a surge in price due to an insufficient bid amount. The upper limit price is set to be different for each product category.

The following is information on upper limit prices published on a web page of the supply-demand balancing market.
An application period of the upper limit price is basically six months, but may be changed.
For calculation of the upper limit price, data for an initial contract of the tertiary balancing capacity (2) for a period of six months in principle is used.
An update of the upper limit price is published on this web page by two weeks before a target date.
After publication of the upper limit price, the upper limit price is notified to trading members by email.
   The supply-demand balancing market system does not check whether a bid price exceeds the upper limit price.
   For a contract at a price exceeding the upper limit price, a charge is calculated by applying the upper limit price at a time of settlement.

In the current supply-demand balancing market, the tertiary balancing capacity (2) is procured in a day-ahead market, and the tertiary balancing capacity (1), the secondary balancing capacity (1), the secondary balancing capacity (2), and the primary balancing capacity are procured in a weekly market.

From calculation criteria of the upper limit prices that are published, a large/small relation of the upper limit prices is represented as follows: (composite product)=(primary balancing capacity)=(secondary balancing capacity (1))>(secondary balancing capacity (2))=(tertiary balancing capacity (1)). However, an upper limit price is not set only for the tertiary balancing capacity (2), which is a product of the day-ahead market. The composite product is described below.

Products of the supply-demand balancing market are subdivided depending on properties as balancing capacity, and each of the products is independently traded, which is a basic concept of the market. However, time points at which a required amount for each product becomes maximum do not necessarily occur at the same time. In the following, a property in which time points at which a required amount for each product becomes maximum do not occur at the same time may be referred to as non-simultaneity. Due to non-simultaneity, it can be considered that a single resource (such as a storage battery) can bid for a plurality of products at the same time. The composite product represents a plurality of products that are bid at the same time in this manner. A concept of the composite product is to reduce a sum total of bid amounts (trading amounts, procurement amounts) by procuring balancing capacity from a resource in consideration of non-simultaneity.

In the following, bidding for a composite product from a single resource may be referred to as composite bidding. In addition, bidding for one product from a single resource may be referred to as single bidding. A product that is bid by single bidding may be referred to as a single product.

In a case of performing composite bidding, bidding is performed for each product included in the composite product within a range in which ΔkW can be provided from a single resource. Among bid amounts for the respective products included in the composite product, a maximum bid amount is regarded as a bid amount for the composite product (a composite bid amount). Products other than a product having the maximum bid amount are bid with an entire bid amount of the product as part of the composite bid amount. In a case of bidding for a composite product, a possibility that a contract is concluded preferentially becomes higher as compared with a case of bidding for a single product, which is an advantage for a power generation company.

In contract logic for a composite product (composite contract logic), for example, in addition to an individual required amount of balancing capacity for each product, a composite required amount of balancing capacity in consideration of non-simultaneity is set. The composite required amount is set, for example, as an amount that can be procured from a single resource at the same time due to non-simultaneity, among required amounts of respective adjacent products. The composite contract logic should be logic that satisfies both an individual required amount and the composite required amount at the same time while minimizing a procurement cost, but specific logic is not known.

An information processing device in the following embodiments generates a bid plan in consideration that a plurality of traded objects such as single products and composite products are traded in a plurality of trading periods (blocks). For example, the information processing device in the embodiment generates a bid plan in consideration of an influence of a bid amount and product selection for a certain block exerted on a bid amount and product selection in subsequent blocks. For example, the information processing device of the embodiment selects whether to bid for a single product or a composite product, and a combination of products, so as to optimize revenue over a plurality of blocks as a whole.

### First Embodiment

An information processing device according to a first embodiment generates a bid plan by generating a plurality of candidates for a bid plan and selecting a candidate that optimizes overall revenue from the candidates.

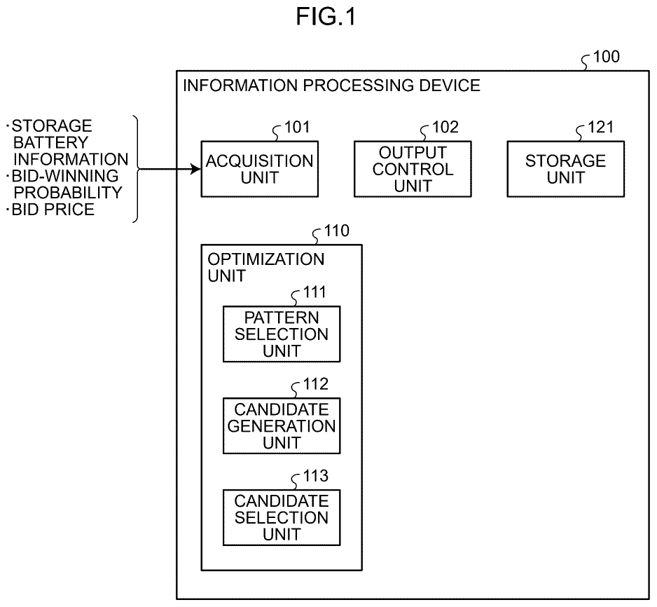

FIG. 1 is a block diagram illustrating an example of a configuration of an information processing device 100 according to the first embodiment. As illustrated in FIG. 1, the information processing device 100 includes an acquisition unit 101, an output control unit 102, an optimization unit 110, and a storage unit 121.

The acquisition unit 101 acquires various kinds of information used by the information processing device 100. A method of acquiring information by the acquisition unit 101 may be any method. For example, a method of receiving information from an external device via a network, a method of reading information from a storage medium, and the like can be applied.

For example, the acquisition unit 101 acquires input data including bid prices and storage battery information (device information) for a plurality of products (traded objects) and for a plurality of blocks. The storage battery information includes a providable amount of balancing capacity (traded object) by a storage battery. The input data may further include a bid-winning probability. The input data for a plurality of blocks may have different values for each unit of a period such as a day, a day of week, and a month, or may have common values for each unit of a period.

In the present embodiment, as the input data such as a bid price, storage battery information, and a bid-winning probability, a value determined in advance is input. A configuration for calculating a bid price and a bid-winning probability in the information processing device will be described in a second embodiment.

The providable amount represents an amount of balancing capacity that can be provided from the storage battery to each product. The storage battery information may further include at least part of the following information.
A time required to store energy (a standby time. such as a time required for charging of the storage battery)
Charge and discharge output
Storage capacity (such as a storage capacity of a rechargeable battery)

The optimization unit 110 generates a highly profitable bid plan by using the acquired input data. For example, the optimization unit 110 generates a bid plan for a plurality of blocks to optimize an evaluation value of trading over the blocks as a whole, with provision conditions for the storage battery to provide balancing capacity used as constraints.

The blocks as targets of optimization correspond to blocks included in a target period (for example, one day) that is determined in advance as a period for generating a bid plan. The bid plan includes patterns of balancing capacity to be traded among a plurality of pieces of balancing capacity, a bid amount of balancing capacity, and a bid price.

The patterns of balancing capacity include a pattern PA (first pattern) including a piece of balancing capacity, and a pattern PB (second pattern) including a plurality of pieces of balancing capacity. The pattern PA corresponds to a single product. The pattern PB corresponds to a composite product.

The following further describes details about a function of the optimization unit 110. The optimization unit 110 includes a pattern selection unit 111, a candidate generation unit 112, and a candidate selection unit 113.

The pattern selection unit 111 selects a pattern of balancing capacity to be bid for each block. At this time, the pattern selection unit 111 uses provision conditions as constraints and selects a pattern that satisfies the constraints. The provision conditions include, for example, a condition based on a providable amount and a condition based on a system of the supply-demand balancing market. The condition based on a providable amount is, for example, a condition indicating that balancing capacity is balancing capacity for which a providable amount is specified by the storage battery information. The condition based on the system of the supply-demand balancing market is, for example, a condition for an upper limit price and a condition for a combination of products.

As described above, in the supply-demand balancing market, there are five types of product categories. Additionally, there are single bidding in which bidding is made for only one of the five types of product categories, and composite bidding in which bidding is made for a plurality of products at the same time. Thus, for example, the pattern PA including one piece of balancing capacity may become five types of patterns at most. On the other hand, since the input data (storage battery information) is specified for each product, input data in which a providable amount is specified may be acquired only for some of the five types of product categories. In such a case, the pattern selection unit 111 selects a pattern including products (product categories) for which the input data has been acquired (selection under a condition based on the providable amount).

An upper limit price is set in the supply-demand balancing market, and even for bidding for the same product, the upper limit price may be different between a case of single bidding and a case of composite bidding. Thus, the pattern selection unit 111 selects a pattern including products for which a bid price included in bid data does not exceed the upper limit price (selection under the condition for the upper limit price).

Additionally, in the supply-demand balancing market, it is stipulated that composite bidding cannot be performed between products of a day-ahead market and products of a weekly market. Therefore, for the pattern PB including a plurality of pieces of balancing capacity, for example, the pattern selection unit 111 selects a pattern in which products of the day-ahead market and products of the weekly market do not coexist (selection under the condition for a combination of products).

For example, it is assumed that input data has been acquired for three types of products including the primary balancing capacity, the tertiary balancing capacity (1), and the tertiary balancing capacity (2). In this case, the pattern selection unit 111 selects four types of possible patterns including single bidding for the primary balancing capacity, single bidding for the tertiary balancing capacity (1), single bidding for the tertiary balancing capacity (2), and composite bidding for the primary balancing capacity and the tertiary balancing capacity (1).

The pattern selection unit 111 outputs one or more patterns selected as describe above to the candidate generation unit 112.

The candidate generation unit 112 generates one or more candidates for a bid plan (hereinafter referred to as bid candidates), each including one or more patterns selected so as to satisfy the provision conditions. In the present embodiment, the candidate generation unit 112 generates one bid candidate for one or more selected patterns. The candidate generation unit 112 stores the generated bid candidate in the storage unit 121. Details about processing of generating the bid candidate by the candidate generation unit 112 will be described later.

The candidate selection unit 113 selects a bid candidate that optimizes revenue from the one or more bid candidates stored in the storage unit 121. For example, the candidate selection unit 113 selects, from among the one or more bid candidates, a bid candidate whose evaluation value over a plurality of blocks as a whole is larger than that of the other bid candidates (for example, a bid candidate having the largest evaluation value). The candidate selection unit 113 generates the selected bid candidate as a bid plan.

For each bid candidate, the candidate selection unit 113 calculates the evaluation value of the bid candidate by using a pattern, a bid amount, and a bid price of each block, and a bid-winning probability (contract probability) at the bid price. For example, the candidate selection unit 113 calculates an expected value of revenue (expected revenue) for each block by the following expression (1).

Expected revenue (yen/block)=bid amount (kW)×bid price (yen/kW·30 minutes)×block length (30 minutes)×bid-winning probability (1)

Since presence or absence of a contract in each block is an independent event, total expected revenue over all blocks of the bid candidate is obtained from a sum total of expected revenue in the respective blocks. That is, the candidate selection unit 113 calculates, for each bid candidate, a sum total of expected revenue over all of the blocks as an evaluation value. The candidate selection unit 113 selects a bid candidate having the largest evaluation value.

The output control unit 102 controls output of various kinds of information used by the information processing device 100. For example, the output control unit 102 outputs the bid plan generated by the optimization unit 110. A method of outputting information may be any method. For example, a method of displaying the information on a display device, a method of transmitting the information to an external device via a network, and the like can be applied.

At least part of the components described above (the acquisition unit 101, the output control unit 102, and the optimization unit 110) may be implemented by one or more processing units. Each of the components described above is implemented by one or a plurality of processors, for example. For example, each of the components described above may be implemented by causing a processor such as a central processing unit (CPU) and a graphics processing unit (GPU) to execute a computer program, that is, by software. Each of the components described above may be implemented by a processor such as a dedicated integrated circuit (IC), that is, by hardware. Each of the components described above may be implemented by using both software and hardware. In a case of using a plurality of processors, each processor may implement one of the components, or may implement two or more of the components.

The storage unit 121 stores various kinds of information used by the information processing device 100. For example, the storage unit 121 stores processing results obtained by the respective components such as the input data acquired by the acquisition unit 101 and the bid candidates generated by the candidate generation unit 112.

The storage unit 121 can be configured by any storage medium that is generally used such as a flash memory, a memory card, a random access memory (RAM), a hard disk drive (HDD), and an optical disc.

The information processing device 100 may be physically configured by one device, or may be physically configured by a plurality of devices. For example, the information processing device 100 may be constructed in a cloud environment. The respective components in the information processing device 100 may be provided to be distributed among a plurality of devices.

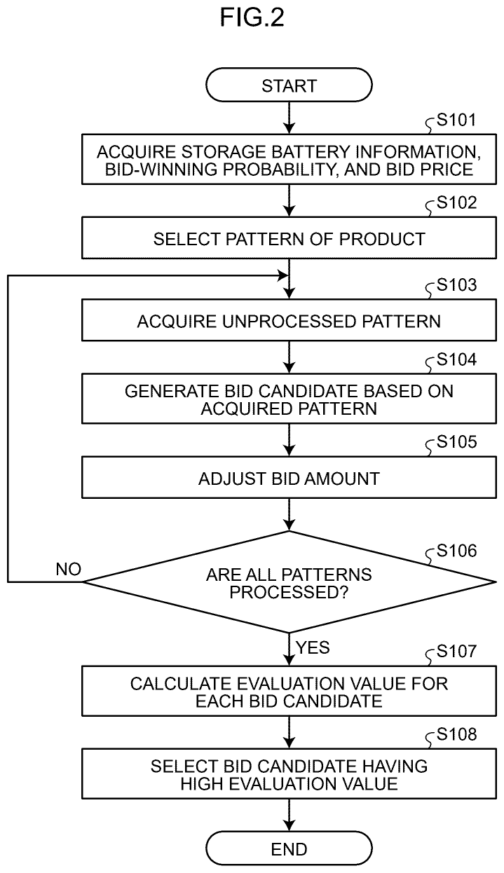

Next, the following describes processing of generating a bid plan by the information processing device 100 according to the first embodiment. FIG. 2 is a flowchart illustrating an example of the processing of generating a bid plan according to the first embodiment. The following also describes details about processing of generating a bid candidate (Step S103 to Step S106) by the candidate generation unit 112 together with the processing of generating a bid plan.

The acquisition unit 101 acquires input data including storage battery information, bid-winning probabilities, and bid prices for a plurality of products and for a plurality of blocks (Step S101).

The pattern selection unit 111 selects a pattern of a product (balancing capacity) for each block by referring to the storage battery information and the like (Step S102).

The candidate generation unit 112 acquires an unprocessed pattern from one or more selected patterns (Step S103). The candidate generation unit 112 generates a bid candidate based on the acquired pattern (Step S104). The candidate generation unit 112 stores the generated input candidate in the storage unit 121.

In the present embodiment, the candidate generation unit 112 generates a bid candidate in which the acquired pattern is applied to all of the blocks. For example, the candidate generation unit 112 generates a bid candidate for bidding all of the blocks for the tertiary balancing capacity (1), a bid candidate for bidding all of the blocks for the primary balancing capacity, a bid candidate for performing composite bidding for all of the blocks for the tertiary balancing capacity (1) and the primary balancing capacity, and the like.

Next, the candidate generation unit 112 determines a bid amount of each block for each bid candidate. First, the candidate generation unit 112 determines, to be a bid amount (provision amount), a value of a providable amount specified in the input data (storage battery information) for a product included in the pattern applied to the bid candidate as it is.

Such a bid amount determined in this manner does not necessarily satisfy provision conditions determined by the storage battery information and the like. Thus, the candidate generation unit 112 adjusts the bid amount so as to satisfy constraints based on the provision conditions. That is, the candidate generation unit 112 adjusts the bid amount that is set based on an available amount for supply (Step S105). The candidate generation unit 112 stores the input candidate after being adjusted in the storage unit 121.

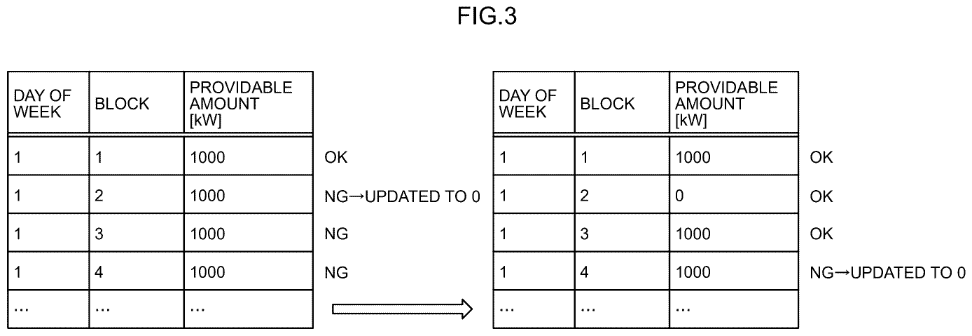

The following describes adjustment of the bid amount. The constraint is, for example, a constraint of a standby time (hereinafter referred to as a standby time constraint). The standby time constraint is a constraint indicating that a standby time required for providing a bid amount to a certain block is sufficiently secured before the block. The following describes a method of adjusting the bid amount in a case of using the standby time constraint. FIG. 3 is a diagram for explaining an example of the method of adjusting the bid amount using the standby time constraint.

The candidate generation unit 112 determines, in order from the first block, whether the standby time constraint is satisfied. However, since there is no information about bid amounts in blocks before the first block, the candidate generation unit 112 determines that the first block satisfies the standby time constraint. In a case where a certain block does not satisfy the standby time constraint, the candidate generation unit 112 updates a bid amount of the block to 0, and continues determination for the standby time constraint for subsequent blocks.

The example of FIG. 3 will be described. FIG. 3 illustrates an example of a case in which 1000 kW is set as a providable amount for each block for a certain day of the week (identification information of a day of week=1). Although FIG. 3 does not illustrate a product, it represents the providable amount for a certain product. The standby time is assumed to be the same as a length of one block (block length).

As described above, assuming that the first block satisfies the standby time constraint, the candidate generation unit 112 adopts the providable amount of 1000 kW as it is as a bid amount of the bid candidate. The second block does not satisfy the standby time constraint because the bid amount of the immediately preceding first block is nonzero. Due to this, the candidate generation unit 112 updates a bid amount of the second block to 0. Since the providable amount of the second block is updated to 0 because it does not satisfy the constraint, a providable amount of the third block satisfies the standby time constraint. Due to this, the candidate generation unit 112 adopts the providable amount of 1000 kW of the third block as it is as the bid amount of the second block. Thereafter, by repeating such a procedure until the last block of the target period of the bid plan, the candidate generation unit 112 determines bid amounts for all of the blocks included in the target period. FIG. 3 illustrates a state in which bid amounts are updated up to the fourth block.

In a case of composite bidding, it is not possible to determine in advance to which product an activation command will be transmitted. Therefore, the candidate generation unit 112 assumes a worst case and performs determination based on the standby time constraint for a product having the longest standby time among products included in the composite product.

In a case where the standby time is not an integral multiple of a length of one block, it is necessary to secure the standby time for a minimum number of blocks having a length equal to or longer than the standby time. For example, in a case where the standby time for 1.5 blocks, a standby time for two blocks is required.

In a case where the standby time is not an integral multiple of the length of one block, the providable amount may be adjusted by a user and the like so that the standby time becomes an integral multiple of the length of one block. For example, a user sets the providable amount to a value smaller than an original providable amount. Input data including the providable amount that is set in this manner is input to the information processing device 100.

The constraint is not limited to the standby time constraint, but may be any other constraint. For example, the constraint may be a constraint on charge and discharge output and a storage capacity. The constraint on charge and discharge output and a storage capacity is, for example, a constraint on a residual capacity of electric power of the storage battery.

For example, assuming that the first block satisfies the standby time constraint, the candidate generation unit 112 sets a value of the providable amount to a bid amount. At the time of setting a bid amount for the second block, the candidate generation unit 112 calculates a residual capacity in a case where the entire bid amount for the first block is contracted and a maximum activation command is transmitted. The candidate generation unit 112 then sets, as the bid amount for the second block, a value equal to or smaller than the residual capacity. For example, the candidate generation unit 112 sets the value of the residual capacity as it is to the bid amount for the second block. Similarly to the case of the standby time constraint, the same processing is repeated for the third block and subsequent blocks.

In a case where a lower limit of the bid amount is set, the candidate generation unit 112 may set the bid amount to 0 when the residual capacity is smaller than the lower limit of the bid amount. The candidate generation unit 112 may calculate the residual capacity on an assumption that charging is performed in each block. For example, the candidate generation unit 112 calculates the residual capacity on an assumption that charging is performed when the residual capacity is lower than a storage capacity at a start of the block.

Returning to the description of FIG. 2. Through the processing from Step S103 to Step S105, one input candidate is generated for one pattern.

The candidate generation unit 112 determines whether all patterns are processed (Step S106). If not all of the patterns are processed (No at Step S106), the candidate generation unit 112 returns the process to Step S103, and acquires the next unprocessed pattern to repeat the processing.

If all of the patterns are processed (Yes at Step S106), the candidate selection unit 113 calculates an evaluation value for each bid candidate (Step S107). For example, the candidate selection unit 113 calculates expected revenue for each block for each bid candidate. Then, the candidate selection unit 113 calculates, for each bid candidate, a sum total of expected revenue of all of the blocks as an evaluation value of the bid candidate. The candidate selection unit 113 selects a bid candidate having a high evaluation value (for example, the evaluation value is largest), and generates the selected bid candidate as a bid plan (Step S108).

A timing of bidding and a timing of contract processing may be different between the weekly market and the day-ahead market in some cases. For example, in the current supply-demand balancing market, contract determination of the weekly market is made earlier than that of the day-ahead market. Due to this, there may be a case where it is required to generate a bid plan for the weekly market earlier. In consideration of such a case, the optimization unit 110 may be configured to generate a bid plan for products of the weekly market, that is, the tertiary balancing capacity (1), the secondary balancing capacity (1), the secondary balancing capacity (2), and the primary balancing capacity.

For example, the acquisition unit 101 acquires information indicating that a bid plan for a product of the weekly market is to be generated, the information being specified by a user or the like. In a case where this information is acquired, the optimization unit 110 performs, for example, the processing described above by using data relating to products of the weekly market in the input data. Similar processing may also be achieved by inputting input data including only products of the weekly market (for example, input data in which a bid amount of a product of the day-ahead market is specified as 0) by a user or the like. Thereafter, for example, processing may be performed such that only blocks that could not be bid in the weekly market are bid in the day-ahead market.

As described above, the information processing device in the first embodiment can generate a bid plan including selection of a product from a plurality of products and a bid amount so that revenue (expected value) is optimized for a plurality of blocks as a whole included in the target period. Due to this, it is possible to obtain optimum bid amounts for a plurality of traded objects in the market with higher accuracy.

### Second Embodiment

The information processing device according to the second embodiment has a function of determining a bid-winning probability and a bid price used for generating a bid plan.

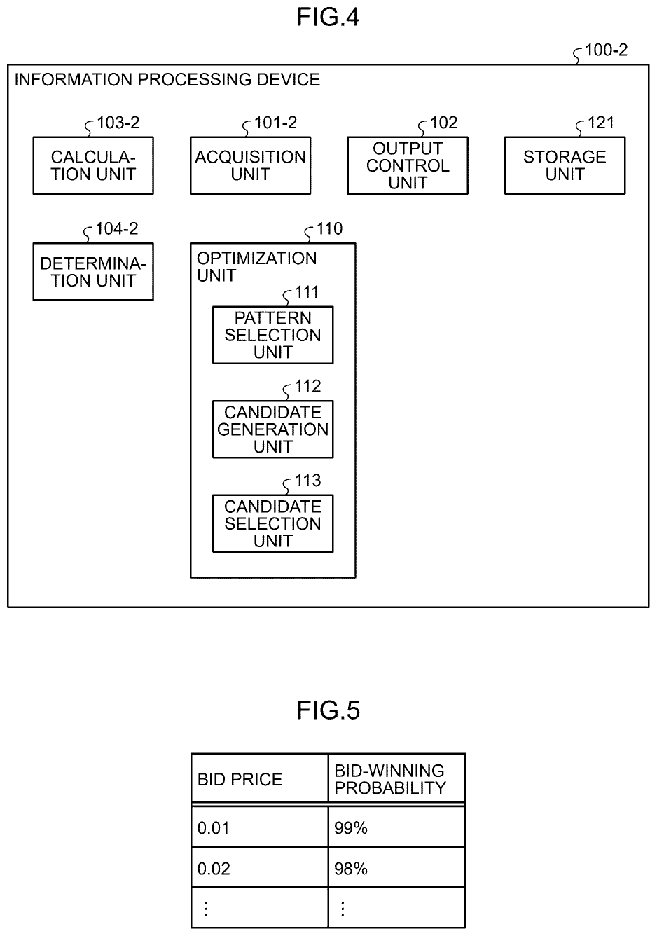

FIG. 4 is a block diagram illustrating an example of a configuration of an information processing device 100-2 according to the second embodiment. As illustrated in FIG. 4, the information processing device 100-2 includes an acquisition unit 101-2, the output control unit 102, the optimization unit 110, the storage unit 121, a calculation unit 103-2, and a determination unit 104-2.

The second embodiment is different from the first embodiment in a function of the acquisition unit 101-2, and in that the calculation unit 103-2 and the determination unit 104-2 are added. Other configurations and functions are the same as those in FIG. 1, which is the block diagram of the information processing device 100 according to the first embodiment, so that the same reference numerals are given thereto, and the description thereof will not be repeated.

The calculation unit 103-2 calculates probability information for obtaining a bid-winning probability by using record of past trading (trading record) in the supply-demand balancing market. The probability information is, for example, a function for calculating a bid-winning probability by using a bid price as a variable (bid-winning probability function). The bid-winning probability is, for example, estimated for each block (trading period) and for each product (traded object). That is, the probability information is information for obtaining a bid-winning probability with respect to a bid price for each block and for each product. The bid-winning probability function may be represented in any format, and may be represented in a table format in which a bid price and a bid-winning probability are associated with each other, for example.

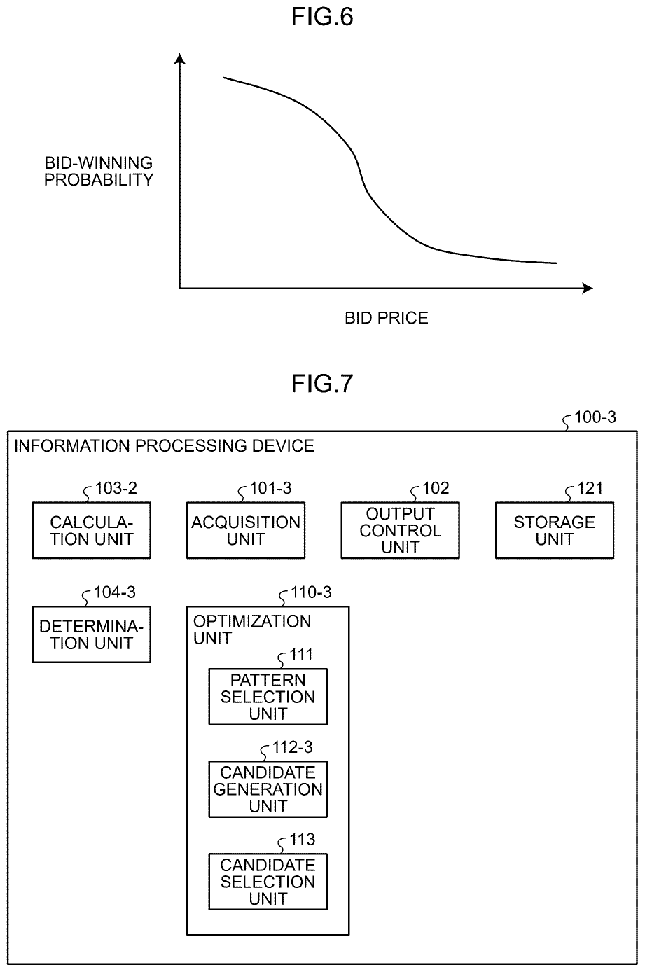

FIG. 5 and FIG. 6 are diagrams illustrating an example of a bid-winning probability function. FIG. 5 illustrates an example of a bid-winning probability function represented in a table format. FIG. 6 is a diagram illustrating a bid-winning probability function by a graph indicating a relation between a bid price and a bid-winning probability.

Returning to the description of FIG. 4. The determination unit 104-2 determines a bid price for each block and for each product so as to maximize expected revenue by using the probability information (bid-winning probability function). Based on the determined bid price, it is possible to determine a bid-winning probability in a case where bidding is performed at the bid price. That is, the determination unit 104-2 can determine, so as to maximize expected revenue, a set of a bid price for each block and for each product and a bid-winning probability in a case where bidding is performed at the bid price.

The acquisition unit 101-2 is different from the acquisition unit 101 in the first embodiment in that bid prices for a plurality of products and for a plurality of blocks are acquired from the determination unit 104-2.

The following describes details about processing of calculating the probability information by the calculation unit 103-2. The calculation unit 103-2 obtains, for each block, a bid-winning probability function having a bid probability as a variable, based on past trading record data published by the supply-demand balancing market, for example.

First, the calculation unit 103-2 obtains a frequency distribution of past highest bid-winning prices of a block that is the same as a block (target block) included in the target period of the bid plan. The calculation unit 103-2 estimates a probability distribution of a highest winning bid price of a future target block based on the frequency distribution.

In a case where one bid price is selected for a certain block, whether a contract is concluded is determined based on whether the selected bid price is lower than the highest winning bid price in the block. Regarding the future target block, since the highest winning bid price is considered to be determined probabilistically, whether a certain bid price is lower than the highest winning bid price is also determined probabilistically.

As described above, if the probability distribution of the highest winning bid price can be estimated, a probability distribution of success or failure of a contract can also be obtained by using the probability distribution of the highest winning bid price. That is, the calculation unit 103-2 can obtain, from the estimated probability distribution of the highest winning bid price, a probability distribution of success or failure of a contract having a bid price as a variable (parameter). The probability distribution of success or failure of a contract having a bid price as a variable corresponds to a bid-winning probability function. Based on the probability distribution of success or failure of a contract having a bid price as a variable (bid-winning probability function), expected revenue having the bid price as a variable can be easily obtained (a function of the determination unit 104-2).

When estimating the probability distribution of the highest winning bid price, market trading record in the past are referred to, but it is necessary to note that the highest winning bid price recorded in the market trading record is the largest value (approximate highest value) among prices actually bid in the market. That is, this value does not directly mean a “highest value of a price at which a contract would have been concluded if bidding had been made for the block” (hereinafter referred to as an ideal highest value). However, to actually estimate a probability distribution of a future highest winning bid price, an ideal highest value of past trading record is required. In a case where not all bid amounts for the market in a certain block are contracted, this means that bid amounts priced at bid prices equal to or higher than the highest winning bid price of the block are not contracted. Accordingly, it is understood that even if an additional bid at the highest winning bid price or more is made, the bid is not contracted. Thus, for such a block, an actual value of the highest winning bid price can be regarded as an ideal highest value.

Next, the following describes details about a method of determining a bid price and a bid-winning probability by the determination unit 104-2. The determination unit 104-2 calculates an optimum bid price and a bid-winning probability for each block based on the bid-winning probability function. For example, the determination unit 104-2 obtains a bid-winning probability by using the bid-winning probability function with, as a variable, bid prices that are changed at fixed values (for example, 0.01 yen/ΔkW·30 minutes) within a range between a minimum bid price and a maximum bid price, and calculates an evaluation value for each block. The minimum bid price and the maximum bid price are values specified in advance, for example. The determination unit 104-2 estimates, for each block, a bid price at which an evaluation value becomes maximum. The evaluation value is, for example, expected revenue calculated by the following expression (2).

Expected revenue (yen/kW⋅block)=bid price (yen/kW⋅30 minutes)×block length (30 minutes)×bid-winning probability (2)

At this time, in a case of a bid plan for a single product, the determination unit 104-2 sets, as an optimum bid price, a bid price with which the evaluation value becomes the highest when the single product is bid, for example.

In a case of a bid plan for a composite product, the determination unit 104-2 sets, as an optimum bid price for the composite product, the largest value among optimum bid prices for respective products included in the composite product, for example. As the bid-winning probability for the composite product, a value obtained by adding a constant to a bid-winning probability of a product having the largest optimum bid price is used. The constant is determined in advance, for example, in accordance with a property that, in a case of bidding for a composite product, a bid-winning probability becomes higher than that in a case of bidding for a single product (heuristic method). An optimum value of the constant can also be searched for based on results obtained by actually performing composite bidding. In a case where a result obtained by adding the constant to the bid-winning probability exceeds 1, processing of rounding the result to 1 is appropriately performed.

As described above, in the second embodiment, a bid-winning probability and a bid price used for generating a bid plan can be determined.

### Third embodiment

The information processing device according to a third embodiment can specify constraints on a bid amount and a bid price.

FIG. 7 is a block diagram illustrating an example of a configuration of an information processing device 100-3 according to the third embodiment. As illustrated in FIG. 7, the information processing device 100-3 includes an acquisition unit 101-3, the output control unit 102, an optimization unit 110-3, the storage unit 121, the calculation unit 103-2, and a determination unit 104-3.

In the third embodiment, functions of the acquisition unit 101-3, the optimization unit 110-3 (a candidate generation unit 112-3), and the determination unit 104-3 are different from those in the second embodiment. Other configurations and functions are the same as those in FIG. 1, which is the block diagram of the information processing device 100-2 according to the second embodiment, so that the same reference numerals are given thereto, and the description thereof will not be repeated.

The acquisition unit 101-3 is different from the acquisition unit 101 of the second embodiment (first embodiment) in that the acquisition unit 101-3 further acquires constraints (conditions) on a bid plan specified by a user or the like. The constraint on a bid plan is, for example, at least one of an upper limit of a bid price, a lower limit of a bid price, a specified value of a bid price, an upper limit of a bid amount, a lower limit of a bid amount, and a specified value of a bid amount.

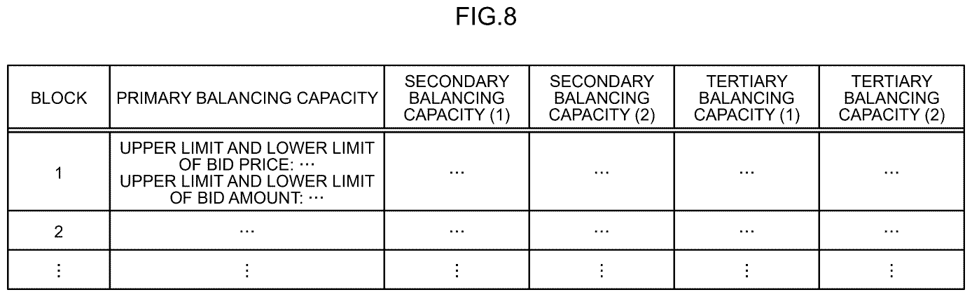

The constraints may be specified in any format, and may be specified in a table format, for example. FIG. 8 is a diagram illustrating an example of a data structure of constraints. FIG. 8 is an example of the constraints represented in a table format. The constraints may be individually set for all blocks in a target period of a bid plan. The constraints may be individually set for blocks for one day, and may be repeatedly used for each day within the target period. The constraints may be set in common for some or all of the blocks included in the target period of the bid plan.

As constraints for at least some of the blocks, specified values may be input. An upper limit of a bid amount or a specified value of a bid amount may be set to 0. In a case where 0 is set, a corresponding block and product can be treated as a block and a product for which bidding is not performed.

Returning to the description of FIG. 7. The optimization unit 110-3 generates a bid plan by using the constraints. For example, in a case where an upper limit of a bid amount is set, the candidate generation unit 112-3 of the optimization unit 110-3 generates a bid candidate by using the set upper limit of the bid amount instead of a providable amount specified by the storage battery information.

The determination unit 104-3 determines a bid price for each block and for each product in accordance with the constraints acquired by the acquisition unit 101-3. For example, for a block for which a specified value of a bid price is not input, the determination unit 104-3 determines a bid price within a specified range between an upper limit (maximum bid price) and a lower limit (minimum bid price) of the bid price. For a block for which a specified value of a bid price is input, the determination unit 104-3 does not perform processing of determining a bid price, and uses the input specified value of the bid price as it is.

A configuration may be made such that the constraints on a bid price (an upper limit, a lower limit, or a specified value) are not acquired. In this case, it may be unnecessary to provide the determination unit 104-3 that determines a bid price in accordance with the constraints on the bid price and the calculation unit 103-2 that calculates probability information used by the determination unit 104-3.

As described above, in the third embodiment, constraints on a bid amount and a bid price can be specified, and determination of a bid price and generation of a bid plan can be performed in accordance with the specified constraints.

### Fourth embodiment

The information processing device according to a fourth embodiment generates a bid plan by expanding bid candidates generated for some of the blocks of the bid plan.

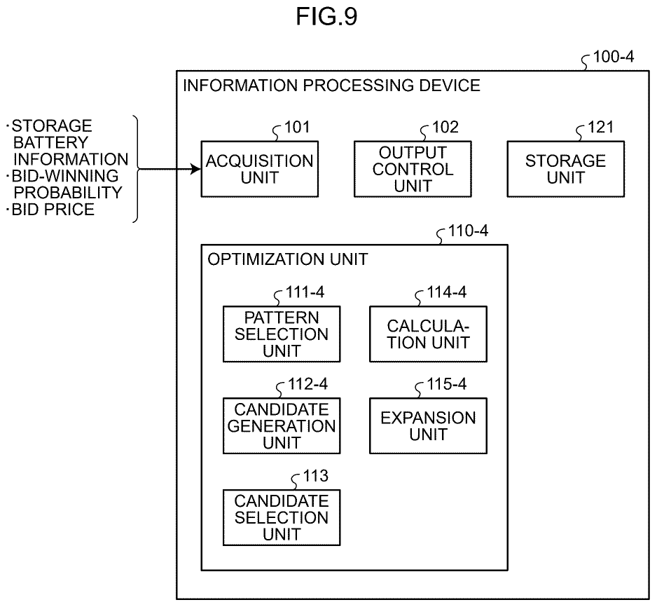

FIG. 9 is a block diagram illustrating an example of a configuration of an information processing device 100-4 according to the fourth embodiment. As illustrated in FIG. 9, the information processing device 100-4 includes the acquisition unit 101, the output control unit 102, an optimization unit 110-4, and the storage unit 121.

In the fourth embodiment, a function of the optimization unit 110-4 is different from that in the first embodiment. Other configurations and functions are the same as those in FIG. 1, which is the block diagram of the information processing device 100 according to the first embodiment, so that the same reference numerals are given thereto, and the description thereof will not be repeated.

The optimization unit 110-4 includes a pattern selection unit 111-4, a candidate generation unit 112-4, the candidate selection unit 113, a calculation unit 114-4, and an expansion unit 115-4. The same configuration as the optimization unit 110 in the first embodiment is denoted by the same reference numeral, and the description thereof will not be repeated.

For blocks up to a block BLA (first trading period) among a plurality of blocks, the pattern selection unit 111-4 selects a pattern of balancing capacity to be bid for each block similarly to the first embodiment. The block BLA is, for example, the first block in the target period of the bid plan. The pattern selection unit 111-4 selects a pattern for a block BLB (second trading period) next to the block BLA among the blocks so as to satisfy provision conditions based on a residual capacity calculated by the calculation unit 114-4. For example, the pattern selection unit 111-4 selects a pattern that can be bid within a range of the residual capacity.

Subsequently, the pattern selection unit 111-4 repeats the processing up to the last block of the target period by setting the block BLB as a new block BLA and setting a block next to the block BLA as a new block BLB.

The candidate generation unit 112-4 generates bid candidates similarly to the first embodiment for blocks up to the block BLA. For blocks (blocks BLB) after the block BLA, expanded bid candidates are generated by the expansion unit 115-4.

The calculation unit 114-4 calculates a residual capacity of electric power of the storage battery used for generating the bid candidate for the block BLB. For example, the calculation unit 114-4 calculates the residual capacity of electric power of the storage battery on an assumption that all bid amounts in a plurality of blocks corresponding to one or more bid candidates CA (first candidates) generated for blocks up to the block BLA are awarded, and discharge of all the awarded bid amounts is instructed. In other words, the calculation unit 114-4 calculates a maximum residual capacity of the storage battery that can be obtained when all bid amounts of the bid candidates CA are contracted, a maximum activation command is transmitted, and discharge is performed in accordance with the activation command.

For example, for a block in which no product is bid, energy storage (charging) can be performed at maximum output. Even for a block that is contracted in the supply-demand balancing market, charging can be performed at output smaller than maximum output in some cases.

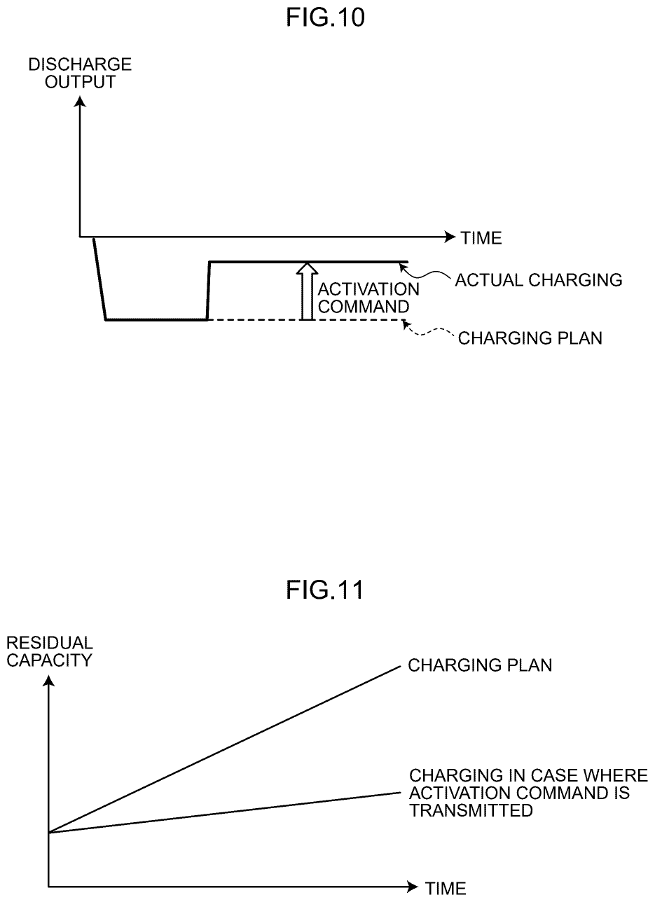

FIG. 10 and FIG. 11 are diagrams for explaining an example of charging in such a case. FIG. 10 illustrates an example of a graph indicating a relation between time and discharge output. A value of discharge output in a charging plan corresponds to maximum output of charging, for example. In a case where an activation command is transmitted, actual discharge output of charging becomes a value smaller than the maximum output corresponding to the activation command.

FIG. 11 illustrates an example of a graph indicating a relation between time and residual capacity on an assumption that the activation command is transmitted. The calculation unit 114-4 can calculate the residual capacity on an assumption that, as illustrated in FIG. 11, an amount of charging when the activation command is transmitted is smaller than an amount of charging in the charging plan.

The expansion unit 115-4 expands the bid candidate CA of the block BLA so as to include bid information of the block BLB by using the calculated residual capacity. For example, the expansion unit 115-4 expands the bid candidate CA by adding, to the bid candidate CA generated for the block BLA (for example, the bid candidate stored in the storage unit 121), the bid information for a block not included in the bid candidate CA (for example, the next block BLB).

At this time, the expansion unit 115-4 determines, for the block BLB, a bid amount within a range of the residual capacity for one or more possible patterns determined (selected) by the pattern selection unit 111-4. The expansion unit 115-4 generates a bid candidate CB (second candidate) obtained by expanding the bid candidate CA so as to include, as a bid candidate for the block BLB, the determined pattern and bid amount, and a bid price.

The optimization unit 110-4 generates, as a bid plan, the bid candidate CB that optimizes an evaluation value among a plurality of the bid candidates CB generated when the block BLB reaches the last block of the target period of the bid plan.

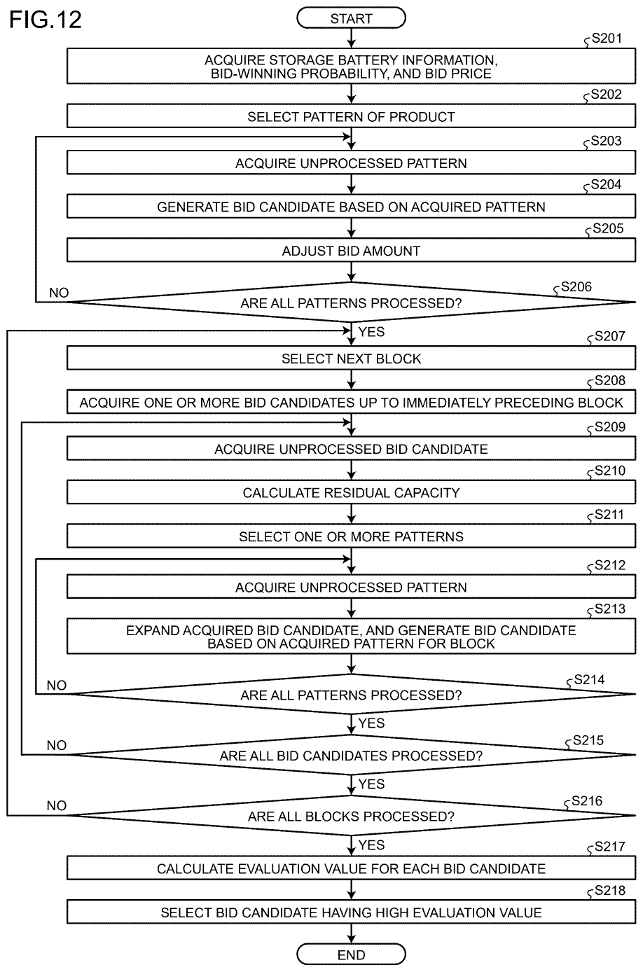

Next, the following describes processing of generating a bid plan by the information processing device 100-4 according to the fourth embodiment with reference to FIG. 12. FIG. 12 is a flowchart illustrating an example of the processing of generating a bid plan according to the fourth embodiment.

The acquisition unit 101 acquires input data including storage battery information, bid-winning probabilities, and bid prices for a plurality of products and for a plurality of blocks (Step S201).

The pattern selection unit 111-4 refers to the storage battery information and the like, and selects a pattern of a product (balancing capacity) for the first block BLA (first block) of the target period of the bid plan (step S202).

The candidate generation unit 112-4 acquires an unprocessed pattern from one or more selected patterns (Step S203). The candidate generation unit 112-4 generates a bid candidate based on the acquired pattern (Step S204).

In the present embodiment, the candidate generation unit 112-4 generates a bid candidate in which the acquired pattern is applied to the first block (block BLA).

Next, the candidate generation unit 112-4 determines a bid amount of the first block for each bid candidate. First, the candidate generation unit 112-4 determines, to be a bid amount (provision amount), a value of a providable amount specified in the input data (storage battery information) for products included in the pattern applied to the bid candidate as it is.

The candidate generation unit 112-4 adjusts the bid amount that is set based on an available amount for supply (Step S205).

The candidate generation unit 112-4 determines whether all patterns are processed (Step S206). If not all of the patterns are processed (No at Step S206), the candidate generation unit 112-4 returns the process to Step S203, and acquires the next unprocessed pattern to repeat the processing.

If all of the patterns are processed (Yes at Step S206), processing of expanding the input candidate is repeatedly performed for blocks after the block BLA (Step S207 to Step S216).

The expansion unit 115-4 selects a block (block BLB) next to the block for which the bid candidate has been generated (Step S207). For example, in the first repetition, the expansion unit 115-4 selects the second block as the block BLB.

The expansion unit 115-4 acquires one or more bid candidates up to an immediately preceding block (step S208). This processing corresponds to acquiring one or more bid candidates generated for the latest block among the bid candidates stored in the storage unit 121.

Hereinafter, for each of the acquired bid candidates, a bid amount and a bid price are determined for a block next to the last block included in the bid candidate, and the determined bid amount and bid price are added to the bid candidate, thereby expanding the bid candidate.

First, the expansion unit 115-4 acquires an unprocessed bid candidate from among one or more acquired bid candidates (Step S209). The calculation unit 114-4 calculates a maximum residual capacity of the storage battery that can be obtained when all bid amounts in the acquired bid candidates are contracted, a maximum activation command is transmitted, and discharge is performed in accordance with the activation command (Step S210).

The pattern selection unit 111-4 selects one or more patterns in the block BLB so as to satisfy provision conditions based on the calculated residual capacity (Step S211).

The expansion unit 115-4 acquires an unprocessed pattern (Step S212). The expansion unit 115-4 expands the bid candidate acquired at Step S209, and generates a bid candidate based on the pattern acquired by the pattern selection unit 111-4 at Step S211 (Step S213).

For example, the expansion unit 115-4 determines, for the block BLB, a bid amount within a range of the residual capacity for the acquired pattern. The expansion unit 115-4 generates the bid candidate CB obtained by expanding the bid candidate CA so as to include, as a bid candidate for the block BLB, the determined pattern and bid amount, and a bid price. The expansion unit 115-4 stores the generated bid candidate CB in the storage unit 121. Due to this, it is possible to obtain one or more bid candidates CB that satisfy the constraints based on the provision conditions and are longer by one block than the original bid candidates CA.

The expansion unit 115-4 determines whether all patterns are processed (Step S214). If not all of the patterns are processed (No at Step S214), the expansion unit 115-4 returns the process to Step S212, and acquires the next unprocessed pattern to repeat the processing.

If all of the patterns are processed (Yes at Step S214), the expansion unit 115-4 determines whether all of the bid candidates are processed (Step S215). If not all of the bid candidates are processed (No at Step S215), the expansion unit 115-4 returns the process to Step S209, and acquires the next unprocessed bid candidate to repeat the processing.

If all of the bid candidates are processed (Yes at Step S215), the expansion unit 115-4 determines whether all of the blocks included in the target period of the bid plan are processed (Step S216). If not all of the blocks are processed (No at Step S216), the expansion unit 115-4 returns the process to Step S207, and acquires the next unprocessed block to repeat the processing.

If all of the blocks are processed (Yes at Step S216), the candidate selection unit 113 calculates an evaluation value for each bid candidate (Step S217). In the present embodiment, the candidate selection unit 113 calculates the evaluation value for each of a plurality of bid candidates expanded to the last block of the target period of the bid plan, among the bid candidates stored in the storage unit 121.

The candidate selection unit 113 selects a bid candidate having a high evaluation value (for example, the evaluation value is largest), and generates the selected bid candidate as a bid plan (Step S218).

A case in which the constraint based on the provision condition is the constraint on the residual capacity has been described as an example. The constraint is not limited thereto, but may be any other constraint. For example, the constraint may be a standby time constraint. In this case, the pattern selection unit 111-4 selects a pattern that satisfies the standby time constraint. As a standby time of each pattern, the largest value among standby times of products included in the pattern is set.

In the processing described above, for example, for each of one or more bid candidates generated for a certain block, expansion of the bid candidate is performed in accordance with one or more patterns selected for the next block. Such expansion processing is repeatedly performed up to the last block of the target period of the bid plan. Due to this, in a case where a large number of bid candidates are generated for one block, and furthermore, a large number of patterns are selected in the next block, the number of bid candidates generated by expansion may become excessive. Accordingly, a function for suppressing the number of bid candidates to be generated may be provided.

For example, the optimization unit 110-4 associates the bid candidate with at least one of the residual capacity and the evaluation value, and stores them in the storage unit 121.

The expansion unit 115-4 compares the evaluation value and residual capacity of the expanded bid candidate with the evaluation value and residual capacity of the bid candidate stored in the storage unit 121, and deletes the bid candidate that is not suitable (for example, a bid candidate having a lower evaluation value among two bid candidates having the same residual capacity). Accordingly, it is possible to suppress the number of bid candidates and reduce a processing load required for generating the bid plan.

In the first embodiment, a bid plan in which the same pattern is selected for all of the blocks included in the target period is generated. In contrast, in the fourth embodiment, a bid plan is generated to expand, on a block-by-block basis, bid candidates that have already been generated. A pattern for each block may be different in consideration of a bid candidate and constraints of a previous block. As described above, in the fourth embodiment, a bid plan can be generated such that different patterns are selected for a plurality of blocks included in the target period.

As described above, according to the first to the fourth embodiments, it is possible to obtain optimum bid amounts for a plurality of traded objects in a market with higher accuracy.

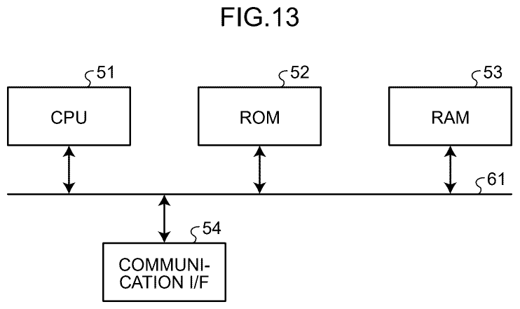

Next, the following describes a hardware configuration of the information processing device according to the first to the fourth embodiment with reference to FIG. 13. FIG. 13 is an explanatory diagram illustrating a hardware configuration example of the information processing device according to the first to the fourth embodiments.

The information processing device according to the first to the fourth embodiments includes a control device such as a central processing unit (CPU) 51, a storage device such as a read only memory (ROM) 52 and a random access memory (RAM) 53, a communication I/F 54 that is connected to a network to perform communication, and a bus 61 that connects the respective components.

A computer program executed by the information processing device according to the first to the fourth embodiments is embedded and provided in the ROM 52 and the like.

The computer program executed by the information processing device according to the first to the fourth embodiments may be recorded in a computer-readable recording medium such as a compact disc read only memory (CD-ROM), a flexible disk (FD), a compact disc recordable (CD-R), and a digital versatile disc (DVD), as an installable or executable file to be provided as a computer program product.

Furthermore, the computer program executed by the information processing device according to the first to the fourth embodiments may be stored in a computer connected to a network such as the Internet and provided by being downloaded via the network. The computer program executed by the information processing device according to the first to the fourth embodiments may be provided or distributed via a network such as the Internet.

The computer program executed by the information processing device according to the first to the fourth embodiments may cause a computer to function as each of the components of the information processing device described above. With this computer, the CPU 51 can read out, from a computer-readable storage medium, a computer program to a main storage device to be executed.

The following describes Configuration Examples of the embodiments.

### Configuration Example 1

An information processing device including:
a processing unit configured to
   using: a bid price for each of a plurality of traded objects with mutually different trading conditions in a market and for each of a plurality of trading periods that are units of bidding in the market; and device information including a providable amount of the traded objects by a providing device configured to provide the traded objects,
   generate a bid plan so as to optimize an evaluation value of trading across the plurality of trading periods with a provision condition for the providing device to provide the traded object as a constraint, the bid plan including a pattern of the traded object to be traded among the plurality of traded objects, and a bid amount and a bid price of the traded object for each of the plurality of trading periods, the provision condition including a condition based on a providable amount.

### Configuration Example 2

The information processing device according to Configuration Example 1, in which the pattern of the traded object includes a first pattern including one traded object and a second pattern including a plurality of the traded objects.

### Configuration Example 3

The information processing device according to Configuration Example 1 or 2, in which
the market is a supply-demand balancing market for electric power, and
the plurality of traded objects include primary balancing capacity, secondary balancing capacity, and tertiary balancing capacity.

### Configuration Example 4

The information processing device according to any one of Configuration Examples 1 to 3, in which
the processing unit is configured to:
   generate one or more candidates for the bid plan each including the respective one or more patterns that satisfy the provision condition,
   select, from among the one or more candidates, the candidate whose evaluation value across the plurality of trading periods is larger than the evaluation value of the other candidate, and
   generate the selected candidate as the bid plan.

### Configuration Example 5

The information processing device according to any one of Configuration Examples 1 to 3, in which
the processing unit is configured to
   using one or more first candidates that are candidates for the bid plan generated for the trading periods up to the first trading period among a plurality of the trading periods, determine the pattern and the bid amount in a second trading period next to the first trading period among the plurality of trading periods so as to satisfy the provision condition;
   generate one or more second candidates obtained by expanding the one or more first candidates so as to include, as candidates for a bid plan of the second trading period, the determined pattern and bid amount, and the bid price; and
   generate, as the bid plan, the second candidate that optimizes the evaluation value among the one or more second candidates that are generated when the second trading period reaches the last trading period among the plurality of trading periods.

### Configuration Example 6

The information processing device according to Configuration Example 5, in which
the providing device includes a storage battery configured to provide electric power as the traded object,
the device information includes charge and discharge output of the storage battery, time required for charging, and a storage capacity, and
the processing unit is configured to:
   calculate a residual capacity of electric power of the storage battery on an assumption that all bid amounts in the plurality of trading periods corresponding to the first candidate are awarded and discharge of all the awarded bid amounts is instructed; and
   determine the pattern and the bid amount in the second trading period so as to satisfy the provision condition indicating that the residual capacity is not exceeded.

### Configuration Example 7

The information processing device according to Configuration Example 6, in which the processing unit is configured to store the candidate and at least one of the residual capacity and the evaluation value in a storage unit in association with each other.

### Configuration Example 8

The information processing device according to any one of Configuration Examples 1 to 7, in which
the device information includes a bid-winning probability for each of the plurality of traded objects and for each of the plurality of trading periods, and
the evaluation value is an expected value of revenue calculated based on the bid-winning probability and the bid price.

### Configuration Example 9

The information processing device according to c any one of Configuration Examples 1 to 8, in which
the processing unit is configured to:
   determine the bid price for each of the trading periods and for each of the traded objects so as to maximize an expected value of revenue using probability information for obtaining a bid-winning probability with respect to the bid price for each of the trading periods and for each of the traded objects, and
   generate the bid plan using the determined bid price.

### Configuration Example 10

The information processing device according to Configuration Example 9, in which the processing unit is configured to calculate the probability information using trading record in the market.

### Configuration Example 11

The information processing device according to any one of Configuration Examples 1 to 10, in which the processing unit is configured to generate the bid plan with, as a further constraint, at least one of an upper limit of the bid price, a lower limit of the bid price, a specified value of the bid price, an upper limit of the bid amount, a lower limit of the bid amount, and a specified value of the bid amount.

### Configuration Example 12

The information processing device according to any one of Configuration Examples 1 to 11, in which
the market is a supply-demand balancing market for electric power, and
the processing unit is configured to generate the bid plan for the traded object as a product in a weekly market traded in the supply-demand balancing market.

### Configuration Example 13

An information processing method performed by an information processing device, the method including:
using: a bid price for each of a plurality of traded objects with mutually different trading conditions in a market and for each of a plurality of trading periods that are units of bidding in the market; and device information including a providable amount of the traded objects by a providing device configured to provide the traded objects,
generating a bid plan so as to optimize an evaluation value of trading across the plurality of trading periods with a provision condition for the providing device to provide the traded object as a constraint, the bid plan including a pattern of the traded object to be traded among the plurality of traded objects, and a bid amount and a bid price of the traded object for each of the plurality of trading periods, the provision condition including a condition based on a providable amount.

### Configuration Example 14

A computer program for causing a computer to perform:
using: a bid price for each of a plurality of traded objects with mutually different trading conditions in a market and for each of a plurality of trading periods that are units of bidding in the market; and device information including a providable amount of the traded objects by a providing device configured to provide the traded objects,
generating a bid plan so as to optimize an evaluation value of trading across the plurality of trading periods with a provision condition for the providing device to provide the traded object as a constraint, the bid plan including a pattern of the traded object to be traded among the plurality of traded objects, and a bid amount and a bid price of the traded object for each of the plurality of trading periods, the provision condition including a condition based on a providable amount.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors configured to
using: a bid price for each of a plurality of traded objects with mutually different trading conditions in a market and for each of a plurality of trading periods that are units of bidding in the market; and device information comprising a providable amount of the traded objects by a providing device configured to provide the traded objects,
generate a bid plan so as to optimize an evaluation value of trading across the plurality of trading periods with a provision condition for the providing device to provide the traded object as a constraint, the bid plan comprising a pattern of the traded object to be traded among the plurality of traded objects, and a bid amount and a bid price of the traded object for each of the plurality of trading periods, the provision condition comprising a condition based on a providable amount.

2. The device according to claim 1, wherein the pattern of the traded object includes a first pattern including one traded object and a second pattern including a plurality of the traded objects.

3. The device according to claim 1, wherein
the market is a market for electric power.

4. The device according to claim 1, wherein
the one or more hardware processors are configured to:
generate one or more candidates for the bid plan each comprising the respective one or more patterns that satisfy the provision condition,
select, from among the one or more candidates, the candidate whose evaluation value across the plurality of trading periods is larger than the evaluation value of the other candidate, and
generate the selected candidate as the bid plan.

5. The device according to claim 1, wherein
the one or more hardware processors are configured to
using one or more first candidates that are candidates for the bid plan generated for the trading periods up to the first trading period among a plurality of the trading periods, determine the pattern and the bid amount in a second trading period next to the first trading period among the plurality of trading periods so as to satisfy the provision condition;
generate one or more second candidates obtained by expanding the one or more first candidates so as to comprise, as candidates for a bid plan of the second trading period, the determined pattern and bid amount, and the bid price; and
generate, as the bid plan, the second candidate that optimizes the evaluation value among the one or more second candidates that are generated when the second trading period reaches the last trading period among the plurality of trading periods.

6. The device according to claim 5, wherein
the providing device comprises a storage battery configured to provide electric power as the traded object,
the device information comprises charge and discharge output of the storage battery, time required for charging, and a storage capacity, and
the one or more hardware processors are configured to:
calculate a residual capacity of electric power of the storage battery on an assumption that all bid amounts in the plurality of trading periods corresponding to the first candidate are awarded and discharge of all the awarded bid amounts is instructed; and
determine the pattern and the bid amount in the second trading period so as to satisfy the provision condition indicating that the residual capacity is not exceeded.

7. The device according to claim 6, wherein the one or more hardware processors are configured to store the candidate and at least one of the residual capacity and the evaluation value in a memory in association with each other.

8. The device according to claim 1, wherein
the device information comprises a bid-winning probability for each of the plurality of traded objects and for each of the plurality of trading periods, and
the evaluation value is an expected value of revenue calculated based on the bid-winning probability and the bid price.

9. The device according to claim 1, wherein
the one or more hardware processors are configured to:
determine the bid price for each of the trading periods and for each of the traded objects so as to maximize an expected value of revenue using probability information for obtaining a bid-winning probability with respect to the bid price for each of the trading periods and for each of the traded objects, and
generate the bid plan using the determined bid price.

10. The device according to claim 9, wherein the one or more hardware processors are configured to calculate the probability information using trading record in the market.

11. The device according to claim 1, wherein the one or more hardware processors are configured to generate the bid plan with, as a further constraint, at least one of an upper limit of the bid price, a lower limit of the bid price, a specified value of the bid price, an upper limit of the bid amount, a lower limit of the bid amount, and a specified value of the bid amount.

12. The device according to claim 1, wherein
the market is a market for electric power, and
the one or more hardware processors are configured to generate the bid plan for the traded object as a product in a weekly market traded in the market.

13. An information processing method performed by an information processing device, the method comprising:
using: a bid price for each of a plurality of traded objects with mutually different trading conditions in a market and for each of a plurality of trading periods that are units of bidding in the market; and device information comprising a providable amount of the traded objects by a providing device configured to provide the traded objects,
generating a bid plan so as to optimize an evaluation value of trading across the plurality of trading periods with a provision condition for the providing device to provide the traded object as a constraint, the bid plan comprising a pattern of the traded object to be traded among the plurality of traded objects, and a bid amount and a bid price of the traded object for each of the plurality of trading periods, the provision condition comprising a condition based on a providable amount.

14. A computer program product comprising a non-transitory computer-readable medium including programmed instructions, the instructions causing a computer to execute:
using: a bid price for each of a plurality of traded objects with mutually different trading conditions in a market and for each of a plurality of trading periods that are units of bidding in the market; and device information comprising a providable amount of the traded objects by a providing device configured to provide the traded objects,
generating a bid plan so as to optimize an evaluation value of trading across the plurality of trading periods with a provision condition for the providing device to provide the traded object as a constraint, the bid plan comprising a pattern of the traded object to be traded among the plurality of traded objects, and a bid amount and a bid price of the traded object for each of the plurality of trading periods, the provision condition comprising a condition based on a providable amount.
